(19) United States
(12) Patent Application Publication
(10) Pub. No.: US 2003/0076101 A1
(43) Pub. Date: Apr. 24, 2003

(54) RF coil and magnetic resonance imaging apparatus

(76) Inventors: Masaaki Sakuma, Tokyo (JP); Kazuya Hoshino, Tokyo (JP)

Correspondence Address: Patrick W. Rasche, Armstrong Teasdale LLP, Suite 2600, One Metropolitan Sq., St. Louis, MO, 63102, US

(21) Appl. No.: 10/265,941

(22) Filed: Oct. 7, 2002

(30) Foreign Application Priority Data
Oct. 18, 2001 (JP) 2001-320330

(51) Int. Cl. G01V 3/00

(52) U.S. Cl. 324/318

(57) ABSTRACT

For the purpose of providing an RF coil that avoids an increase in vertical size due to a connector, the present RF coil comprises: a panel-like base member (302); a flexible member (304) having an electric circuit for the RF coil, bending to surround a space adjacent to one surface of the base member, having both ends joined to the base member, and forming a generally circular cylinder along with the base member; and a connecting member (306) enabling connection and disconnection of the circumferential continuity of the cylinder at a position other than one corresponding to the top portion of the cylinder of the flexible member.

### BACKGROUND OF THE INVENTION

The present invention relates to an RF (radio frequency) coil and a magnetic resonance imaging apparatus, and particularly to an RF coil disposed proximate to and surrounding a subject to be imaged, and a magnetic resonance imaging apparatus employing such an RF coil.

In a magnetic resonance imaging apparatus, an RF coil is disposed proximate to and surrounding a subject to be imaged so that magnetic resonance signals are measured as close to a region to be imaged as possible to improve the SNR (signal-to-noise ratio) of the signals.

A representative example of such an RF coil is a cylindrical RF coil for inserting the subject's head, i.e., a head coil. In a magnetic resonance imaging apparatus employing a magnetic field of a strength as low as 0.2 T, for example, such an RF coil is also employed for imaging the subject's trunk. In this case, the RF coil is constructed to be developable. The developed RF coil is placed on an imaging table, the subject is rested over the developed RF coil, and finally the developed portion of the RF coil is closed to form the cylinder.

The developable RF coil is comprised of a pair of band-shaped flexible members each having one end attached to one end of a horizontal base member. When the cylinder is formed, the other ends of the pair of flexible members are bent to face each other in an upper space of the base member and connected by a connector.

Since the connector lies at the top portion when the cylinder is formed in such an RF coil, the height from the bottom surface of the base member to the upper surface of the connector corresponds to the vertical size of the RF coil.

In a magnet system of a vertical magnetic field type, the RF coil is brought into the imaging space with its vertical dimension aligned to the direction of the static magnetic field, and therefore, the distance between pole pieces of the magnet system must be larger than the vertical size of the RF coil. In general, as the distance between the pole pieces becomes larger, a stronger magnet is needed to obtain a specified magnetic field strength. Hence, the vertical size of the RF coil is desirably as small as possible insofar as it can receive the subject to be imaged.

### SUMMARY OF THE INVENTION

It is therefore an object of the present invention is to provide an RF coil that avoids an increase of the vertical size due to the connector, and a magnetic resonance imaging apparatus comprising such an RF coil.

(1) The present invention, in one aspect thereof for solving the aforementioned problem, is an RF coil characterized in comprising: a panel-like base member; a flexible member having an electric circuit for the RF coil, bending to surround a space adjacent to one surface of said base member, having both ends joined to said base member, and forming a generally circular cylinder along with said base member; and a connecting member enabling connection and disconnection of the circumferential continuity of said cylinder at a position other than one corresponding to the top portion of said cylinder of said flexible member.

(2) The present invention, in another aspect thereof for solving the aforementioned problem, is a magnetic resonance imaging apparatus having static magnetic field generating means for generating a static magnetic field in a space for receiving a subject to be imaged, gradient magnetic field generating means for generating a gradient magnetic field in said space, high frequency magnetic field generating means for generating a high frequency magnetic field in said space, measuring means for measuring magnetic resonance signals from said subject, and image producing means for producing an image based on said magnetic resonance signals, wherein said measuring means has an RF coil, said RF coil characterized in comprising: a panel-like base member; a flexible member having an electric circuit for the RF coil, bending to surround a space adjacent to one surface of said base member, having both ends joined to said base member, and forming a generally circular cylinder along with said base member; and a connecting member enabling connection and disconnection of the circumferential continuity of said cylinder at a position other than one corresponding to the top portion of said cylinder of said flexible member.

(3) The present invention, in still another aspect thereof for solving the aforementioned problem, is an RF coil characterized in comprising: a panel-like base member; a flexible member having an electric circuit for the RF coil, bending to surround a space adjacent to one surface of said base member, having both ends joined to said base member, and forming a generally semicircular cylinder along with said base member; and a connecting member enabling connection and disconnection of the circumferential continuity of said cylinder at a position other than one corresponding to the top portion of said cylinder of said flexible member.

(4) The present invention, in still another aspect thereof for solving the aforementioned problem, is a magnetic resonance imaging apparatus having static magnetic field generating means for generating a static magnetic field in a space for receiving a subject to be imaged, gradient magnetic field generating means for generating a gradient magnetic field in said space, high frequency magnetic field generating means for generating a high frequency magnetic field in said space, measuring means for measuring magnetic resonance signals from said subject, and image producing means for producing an image based on said magnetic resonance signals, wherein said measuring means has an RF coil, said RF coil characterized in comprising: a panel-like base member; a flexible member having an electric circuit for the RF coil, bending to surround a space adjacent to one surface of said base member, having both ends joined to said base member, and forming a generally semicircular cylinder along with said base member; and a connecting member enabling connection and disconnection of the circumferential continuity of said cylinder at a position other than one corresponding to the top portion of said cylinder of said flexible member.

In the invention of the aspects described regarding (1)-(4), since a connecting member that enables connection and disconnection of the circumferential continuity of the cylinder at a position other than one corresponding to the top portion of the cylinder of the flexible member is provided, the height from the bottom surface of the base member to the upper surface of the flexible member corresponds to the vertical size of the RF coil.

The connecting member is preferably disposed at a position other than an end of the flexible member so that the connection/disconnection work for the cylinder can be done on one side of the RF coil.

The connecting member is preferably disposed at an end of the flexible member so that the flexible member can be made continuous.

The connecting member is preferably disposed at two positions opposite to each other with respect to the center axis of the cylinder so that the connection/disconnection work for the cylinder can be done on either side of the RF coil.

Therefore, the present invention provides an RF coil that avoids an increase of the vertical size due to a connector, and a magnetic resonance imaging apparatus comprising such an RF coil.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram of an apparatus in accordance with one embodiment of the present invention.

FIG. 2 is a schematic diagram showing an example of a pulse sequence executed by the apparatus in accordance with the embodiment of the present invention.

FIG. 3 is a schematic diagram showing another example of a pulse sequence executed by the apparatus in accordance with the embodiment of the present invention.

FIG. 4 is a schematic view showing a typical configuration of a receive coil section.

FIG. 5 is a schematic view showing a typical configuration of the receive coil section.

FIG. 6 is a schematic view showing a procedure for accommodating a subject to be imaged within the receive coil section.

FIG. 7 is a schematic view showing the procedure for accommodating the subject to be imaged within the receive coil section.

FIG. 8 is a schematic view showing the procedure for accommodating the subject to be imaged within the receive coil section.

FIG. 9 is a schematic view showing a condition in which a conventional receive coil section is employed.

FIG. 10 is a schematic view showing a typical configuration of the receive coil section.

FIG. 11 is a schematic view showing a typical configuration of the receive coil section.

FIG. 12 is a schematic view showing a typical configuration of the receive coil section.

FIG. 13 is a schematic view showing a typical configuration of the receive coil section.

FIG. 14 is a schematic view showing a typical configuration of the receive coil section.

FIG. 15 is a schematic view showing a typical configuration of the receive coil section.

FIG. 16 is a schematic view showing a typical configuration of the receive coil section.

FIG. 17 is a schematic view showing a typical configuration of the receive coil section.

FIG. 18 is a schematic view showing a typical configuration of the receive coil section.

FIG. 19 is a schematic view showing a typical configuration of the receive coil section.

FIG. 20 is a schematic view showing a typical configuration of the receive coil section.

FIG. 21 is a broken-away view showing part of the configuration of a flexible portion.

FIG. 22 shows electric circuit diagrams of the receive coil section.

FIG. 23 is a diagram for explaining the function of a shape defining member.

FIG. 24 is a diagram for explaining the function of the shape defining member.

### DETAILED DESCRIPTION OF THE INVENTION

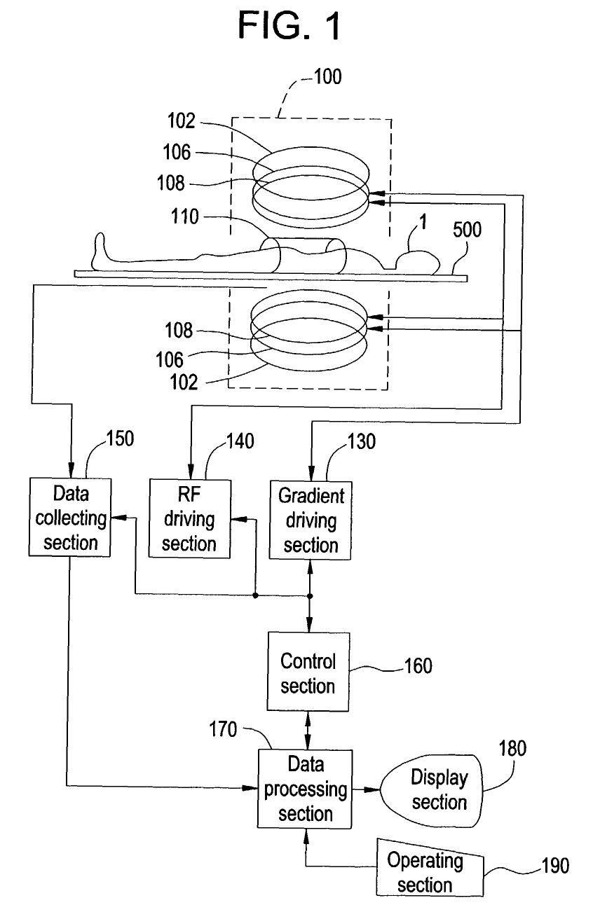

Several embodiments of the present invention will now be described in detail with reference to the accompanying drawings. It should be noted that the present invention is not limited to the embodiments. FIG. 1 is a block diagram of a magnetic resonance imaging apparatus, which is one embodiment of the present invention. The configuration of the apparatus represents an embodiment of the apparatus in accordance with the present invention.

As shown in FIG. 1, the present apparatus has a magnet system 100. The magnet system 100 has a main magnetic field magnet section 102, a gradient coil section 106, and a transmit coil section 108. The main magnetic field magnet section 102, gradient coil section 106 and transmit coil section 108 each comprise a pair of members facing each other across a space. These sections have a generally disk-like shape and are disposed to have a common center axis. The main magnetic field magnet section 102 is an embodiment of the static magnetic field generating means of the present invention.

A subject 1 is rested on a cradle 500 and carried into and out of the internal space (bore) of the magnet system 100 by carrier means, which is not shown. The trunk of the subject 1 is received within a cylindrical receive coil section 110.

The receive coil section 110 is an embodiment of the RF coil of the present invention. The configuration of the coil represents an embodiment of the RF coil in accordance with the present invention. The receive coil section 110 will be described in more detail later.

The main magnetic field magnet section 102 generates a static magnetic field in the internal space of the magnet system 100. The direction of the static magnetic field is generally orthogonal to the direction of the body axis of the subject 1. That is, a so-called vertical magnetic field is generated. The main magnetic field magnet section 102 is constructed using a permanent magnet, for example. It will be easily recognized that the main magnetic field magnet section 102 is not limited to a permanent magnet, but may be made using a super or normal conductive electromagnet or the like.

The gradient coil section 106 generates three gradient magnetic fields for imparting respective gradients to the static magnetic field strength in directions of three mutually perpendicular axes, i.e., slice axis, phase axis, and frequency axis.

When mutually perpendicular coordinate axes in the static magnetic field space are represented as x, y, and z, any one of the axes can be the slice axis. In this case, one of the two remaining axes is the phase axis and the other is the frequency axis. Moreover, the slice, phase, and frequency axes can be given arbitrary inclination with respect to the x-, y-, and z-axes while maintaining their mutual perpendicularity.

The gradient magnetic field in the slice axis direction is sometimes referred to as the slice gradient magnetic field. The gradient magnetic field in the phase axis direction is sometimes referred to as the phase encoding gradient magnetic field. The gradient magnetic field in the frequency axis direction is sometimes referred to as the readout gradient magnetic field. In order to enable generation of such gradient magnetic fields, the gradient coil section 106 has three gradient coils, which are not shown. The gradient magnetic field will be sometimes referred to simply as the gradient hereinbelow.

The RF coil section 108 generates a high frequency magnetic field for exciting spins within the subject 1 in the static magnetic field space. The generation of the high frequency magnetic field will be sometimes referred to as transmission of the RF excitation signals hereinbelow. Moreover, the RF excitation signal will be sometimes referred to as an RF pulse. The receive coil section 110 receives electromagnetic waves generated by the excited spins, i.e., magnetic resonance signals.

The gradient coil section 106 is connected with a gradient driving section 130. The gradient driving section 130 supplies driving signals to the gradient coil section 106 to generate the gradient magnetic fields. The gradient driving section 130 has three driving circuits, which are not shown, corresponding to the three gradient coils in the gradient coil section 106. A portion comprised of the gradient coil section 106 and gradient driving section 130 is an embodiment of the gradient magnetic field generating means of the present invention.

The RF coil section 108 is connected with an RF driving section 140. The RF driving section 140 supplies driving signals to the RF coil section 108 to transmit the RF pulse, thereby exciting the spins within the subject 1. A portion comprised of the RF coil section 108 and RF driving section 140 is an embodiment of the high frequency magnetic field generating means of the present invention.

The receive coil section 110 is connected to a data collecting section 150. The data collecting section 150 gathers receive signals received by the receive coil section 110 by sampling them, and collects the signals as digital data. A portion comprised of the receive coil section 110 and data collecting section 150 is an embodiment of the measuring means of the present invention.

The gradient driving section 130, RF driving section 140 and data collecting section 150 are connected with a control section 160. The control section 160 controls the gradient driving section 130, RF driving section 140 and data collecting section 150 to carry out imaging.

The control section 160 is constructed using, for example, a computer. The control section 160 has a memory, which is not shown. The memory stores programs for the control section 160 and several kinds of data. The function of the control section 160 is achieved by the computer executing a program stored in the memory.

The output of the data collecting section 150 is connected to a data processing section 170. The data collected by the data collecting section 150 is input to the data processing section 170. The data processing section 170 is constructed using, for example, a computer. The data processing section 170 has a memory, which is not shown. The memory stores programs for the data processing section 170 and several kinds of data.

The data processing section 170 is connected to the control section 160. The data processing section 170 is above the control section 160 and controls it. The function of the present apparatus is achieved by the data processing section 170 executing a program stored in the memory.

The data processing section 170 stores data collected by the data collecting section 150 into the memory. A data space is formed in the memory. The data space constitutes a two-dimensional Fourier space. The Fourier space will be sometimes referred to as a k-space hereinbelow. The data processing section 170 performs a two-dimensional inverse Fourier transformation on the data in the k-space to reconstruct an image of the subject 1. The data processing section 170 is an embodiment of the image producing means of the present invention.

The data processing section 170 is connected with a display section 180 and an operating section 190. The display section 180 comprises a graphic display, etc. The operating section 190 comprises a keyboard, etc., provided with a pointing device.

The display section 180 displays the reconstructed image and several kinds of information output from the data processing section 170. The operating section 190 is operated by a user, and the section 190 inputs several commands, information and so forth to the data processing section 170. The user interactively operates the present apparatus via the display section 180 and operating section 190.

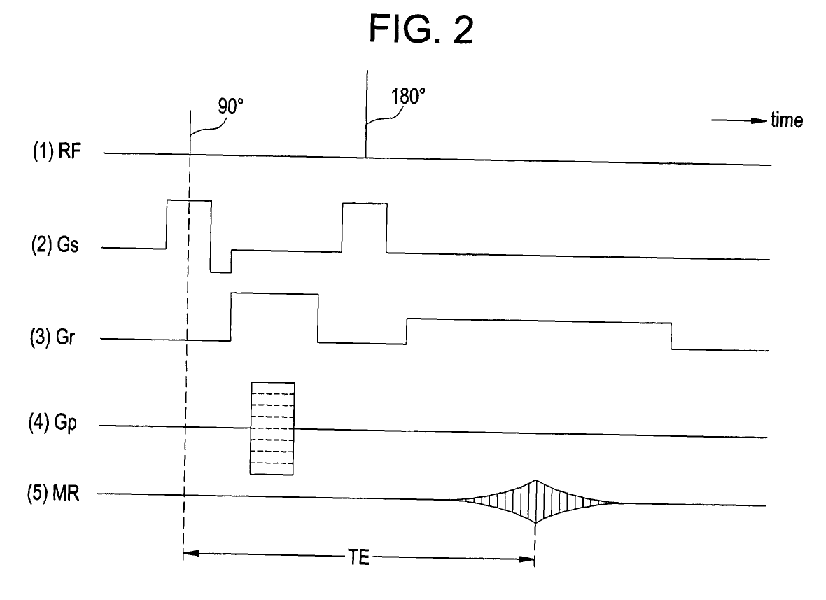

FIG. 2 shows an exemplary pulse sequence for use in magnetic resonance imaging. The pulse sequence is one according to a spin echo (SE) technique.

Specifically, (1) is a sequence of 90° and 180° pulses for RF excitation of the SE technique; and (2), (3), (4), and (5) are sequences of a slice gradient Gs, readout gradient Gr, phase encoding gradient Gp, and spin echo MR, respectively, of the SE technique. The 90° and 180° pulses are represented by their respective center signals. The pulse sequence proceeds along a time axis t from the left to the right.

As shown, a 90° pulse achieves 90° excitation of the spins. At this time, the slice gradient Gs is applied to perform selective excitation of a certain slice. After a specified time from the 90° excitation, a 180° pulse achieves 180° excitation, i.e., spin inversion. Also at this time, the slice gradient Gs is applied to perform selective excitation of the same slice.

In the period between the 90° excitation and spin inversion, the readout gradient Gr and phase encoding gradient Gp are applied. The readout gradient Gr dephases the spins. The phase encoding gradient Gp phase-encodes the spins.

After the spin inversion, rephasing of the spins is performed by the readout gradient Gr to generate a spin echo MR. The spin echo MR is collected by the data collecting section 150 as view data. Such a pulse sequence is repeated 64-256 times in a cycle TR (repetition time). The phase encoding gradient Gp is changed for each repetition to provide different phase encoding each time. Thus, view data are obtained for 64-256 views.

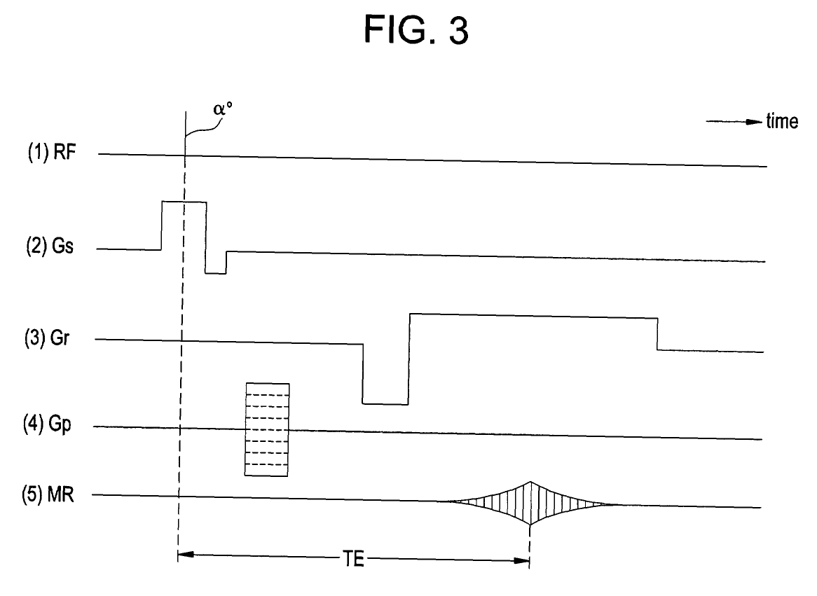

Another example of the pulse sequence for magnetic resonance imaging is shown in FIG. 3. This pulse sequence is one according to a gradient echo (GRE) technique.

Specifically, (1) is a sequence of an α° pulse for RF excitation of the GRE (Gradient Echo) technique, and (2), (3), (4), and (5) are sequences of a slice gradient Gs, readout gradient Gr, phase encoding gradient Gp, and spin echo MR, respectively, of the GRE technique. It should be noted that the α° pulse is represented by its central signal. The pulse sequence proceeds along a time axis t from the left to the right.

As shown, the α° pulse achieves α° excitation of the spins, wherein α is not greater than 90. At the same time, the slice gradient Gs is applied to achieve selective excitation for a certain slice.

After the α° excitation, the spins are phase-encoded by the phase encoding gradient Gp. Next, the spins are first dephased and are subsequently rephased by the readout gradient Gr to generate a gradient echo MR. The gradient echo MR is collected by the data collecting section 150 as view data. Such a pulse sequence is repeated 64-512 times in a cycle of TR. The phase encoding gradient Cp is changed for each repetition to provide different phase encoding each time. Thus, view data for 64-512 views are obtained.

The view data obtained by the pulse sequence of FIG. 2 or 3 are collected into the memory in the data processing section 170. It will be easily recognized that the pulse sequence is not limited to that of the SE or GRE technique, but may be of any other appropriate technique such as a fast spin echo (FSE) technique or an echo planar imaging (EPI) technique.

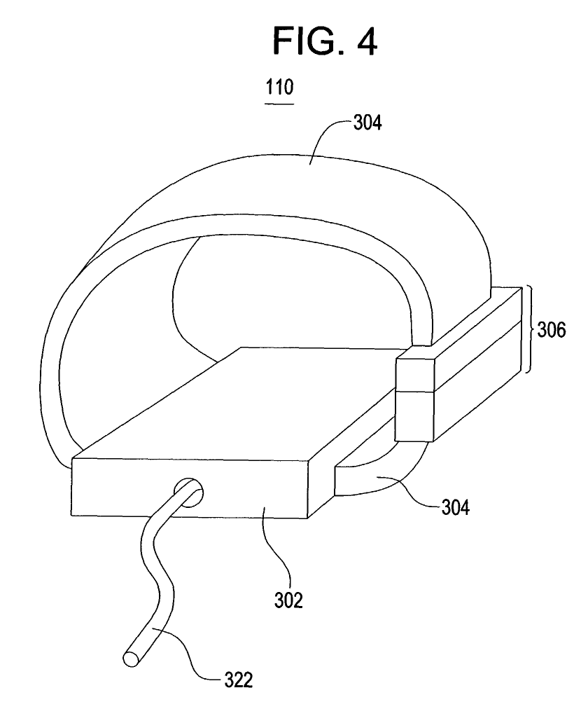

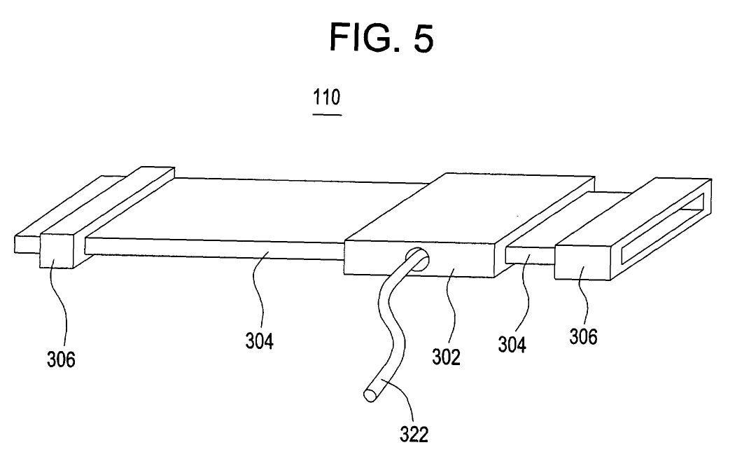

Now the receive coil section 110 will be described. FIGS. 4 and 5 schematically show a typical configuration of the receive coil section 110. FIG. 4 is a schematic perspective view of the receive coil section 110 formed into a cylinder, and FIG. 5 is a schematic perspective view thereof when the cylinder is developed into a plane.

As shown, the receive coil section 110 has a base portion 302 and a pair of flexible portions 304 attached to opposite lateral sides of the base portion 302. The flexible portions 304 are unequal in length. The base portion 302 is provided with a cable 322 for outputting received signals. The base portion 302 is an embodiment of the base member of the present invention. The flexible portions 304 represent an embodiment of the flexible member of the present invention.

One end of each flexible portion 304 is attached to one side of the base portion 302 to face the corresponding end of the other. These are fixed ends of the flexible portions 304. The other ends of the flexible portions 304 are free ends. Each free end is attached with one of a pair of units of a connector 306. The connector 306 represents an embodiment of the connecting member of the present invention.

The free ends of the flexible portions 304 are joined by the connector 306 to form a generally circular cylinder along with the base portion 302. The flexible portions 304 are provided with members described later for maintaining such a cylindrical shape. The connector is positioned on the lateral side of the cylinder. In performing imaging, the subject 1 is received in the internal space of the cylinder.

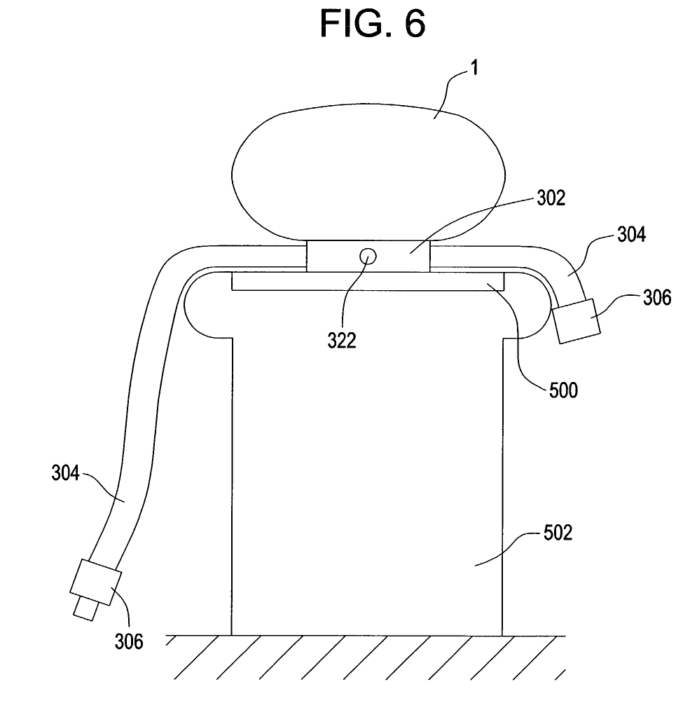

FIGS. 6-8 show how the subject 1 is received within the receive coil section 110. As shown, the base portion 302 is placed on the cradle 500. The cradle 500 is mounted on a table 502. The cradle 500 can be moved forward/backward in a direction perpendicular to the drawing plane of FIG. 6.

When the connector 306 is disconnected to develop the receive coil section 110, the flexible portions 304 hang down on opposite sides of the table 502. The subject 1 is rested over the cradle 500 and the base portion 302 at a holding position of the cradle 500 with the flexible portions 304 hanging down on opposite sides of the table 502 as described above. After the subject 1 has been rested, the flexible portions 304 are wrapped around the subject 1 from opposite sides.

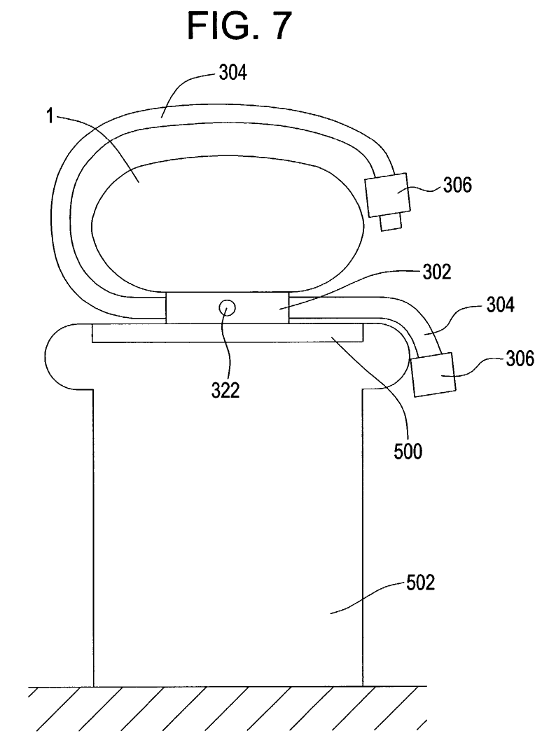

If this work is done by an operator standing on the right side of the table 502, the operator first stretches his/her arm over the subject 1 toward the opposite side of the table 502, grasps and lifts the flexible portion 304, and brings its free end to the right side of the subject 1, as shown in FIG. 7.

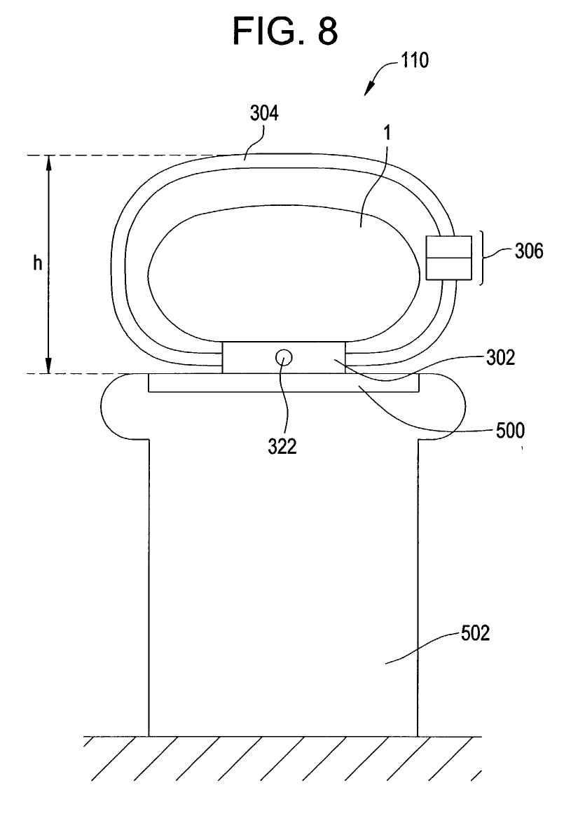

The operator next lifts the flexible portion 304 on the right side, and joins the free ends by the connector 306. Thus, the subject 1 is received within the cylinder formed by the receive coil section 110, as shown in FIG. 8

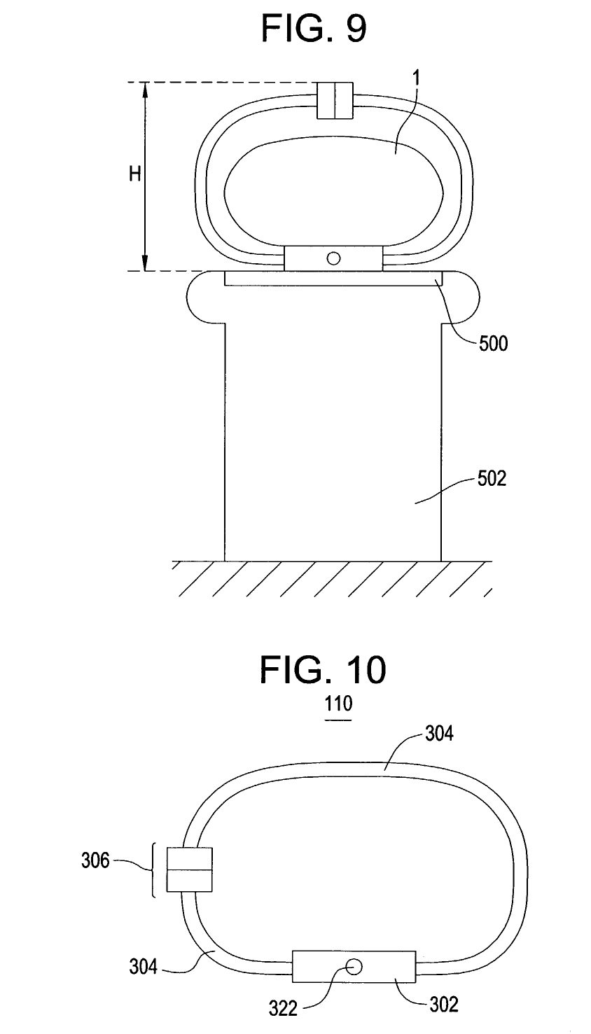

Since the connector 306 lies on the lateral side of the cylinder, the height of the receive coil section 110 is equal to the height h from the bottom surface of the base portion 302 to the top surface of the flexible section 304. Comparing this height with that when a conventional receive coil section is employed, the height of the conventional receive coil section is H (>h) because the conventional receive coil section has the connector at the top portion and the thickness of the connector is larger than that of the flexible portions, as shown in FIG. 9.

In order to receive a subject of the same size, since the lower surface of the connector protrudes inward of the cylinder relative to the lower surface of the flexible portions, the level of the lower surface of the flexible portions must be raised by a corresponding amount. Thus, H is larger than h by the difference in thickness between the connector and flexible portion.

However, since the connector 306 is positioned on the lateral side of the cylinder of the receive coil section 110, the increase of height due to the connector lying at the top portion of the cylinder experienced by the conventional receive coil section can be prevented. Therefore, the height of the receive coil section can be reduced relative to the conventional receive coil section. For example, when the thickness of the connector is 30 mm and the thickness of the flexible portion is 15 mm, the height of the receive coil section 110 can be reduced by 15 mm relative to the conventional one.

Moreover, the distance between the pole pieces of the magnet system 100 can be reduced corresponding to such a decrease in height of the receive coil section 110, and a specified magnetic field strength can be generated using a weaker magnet.

The connector 306 may be positioned on the left lateral side of the cylinder, as exemplarily shown in FIG. 10. Such a receive coil section 110 is convenient for a user who, owing to certain circumstances, must work on the left side of the table 502.

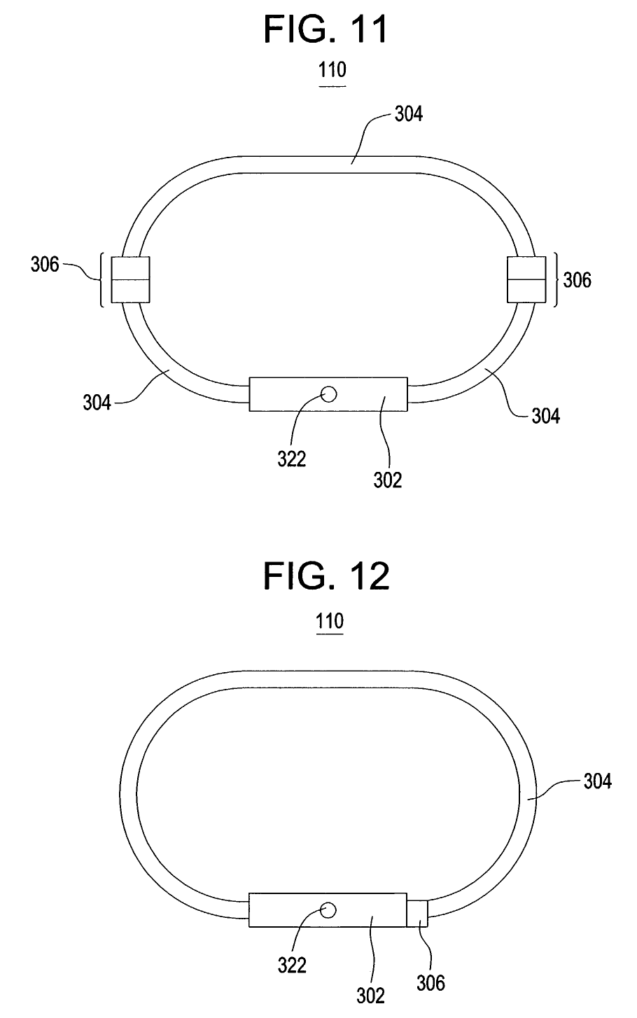

Moreover, connectors 306 may be provided on both lateral sides of the cylinder, as exemplarily shown in FIG. 11. This provides a receive coil section 110 that allows the operator to work on either side. It should be noted that such connectors 306 should have a releasable lock mechanism.

The receive coil section 110 may have only one flexible portion 304 whose one end is fixed to the left side of the base portion 302 and the other end is connected to the right side of the base portion 302 via the connector 306, as exemplarily shown in FIG. 12. This unifies the flexible portion 304.

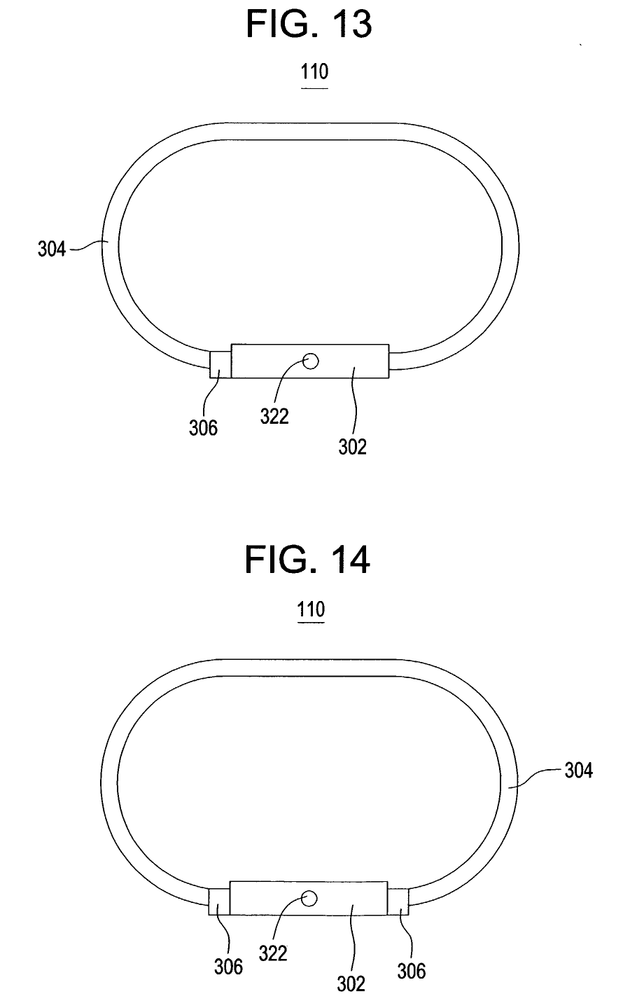

Alternatively, the fixed side of the flexible portion 304 and the connector side may be exchanged from left (right) to right (left) to form the receive coil section 110 as shown in FIG. 13; or the both ends may be connected to the base section 302 by connectors 306, as shown in FIG. 14.

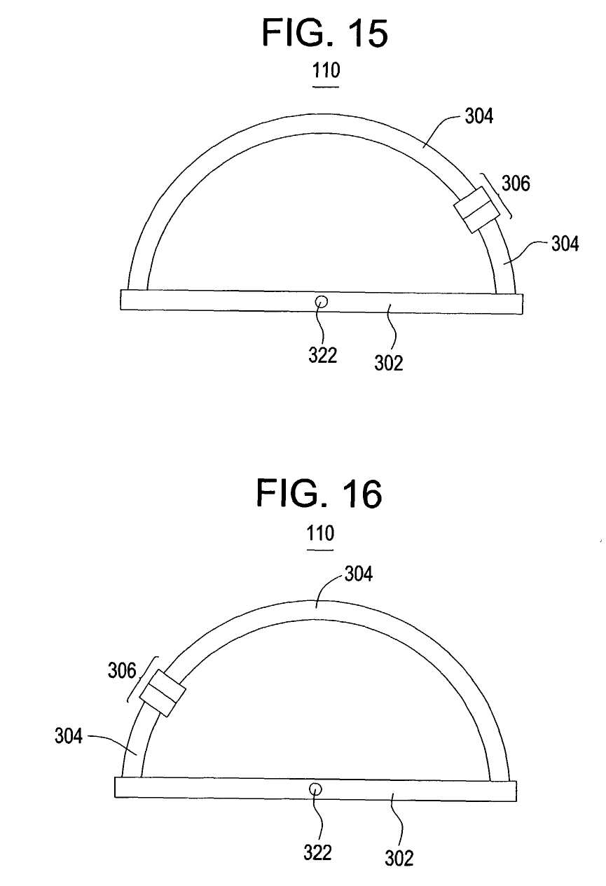

The cylinder formed by the base portion 302 and the flexible portion 304 is not limited to the generally circular one, but it may be a generally semicircular cylinder as shown in FIGS. 15-20, for example.

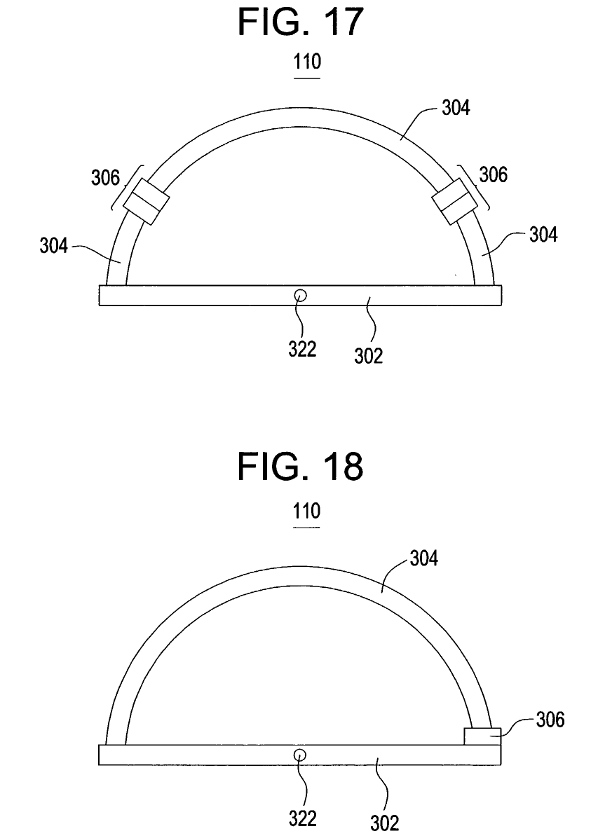

FIGS. 15-17 show a semicircular cylinder in which the connector(s) 306 is/are disposed at intermediate point(s) of the flexible portion 304 on the lateral side(s) of the cylinder. FIG. 15 shows an example in which a connector 306 is disposed on the right side; FIG. 16 shows an example in which a connector 306 is disposed on the left side; and FIG. 17 shows an example in which connectors 306 are disposed on both sides.

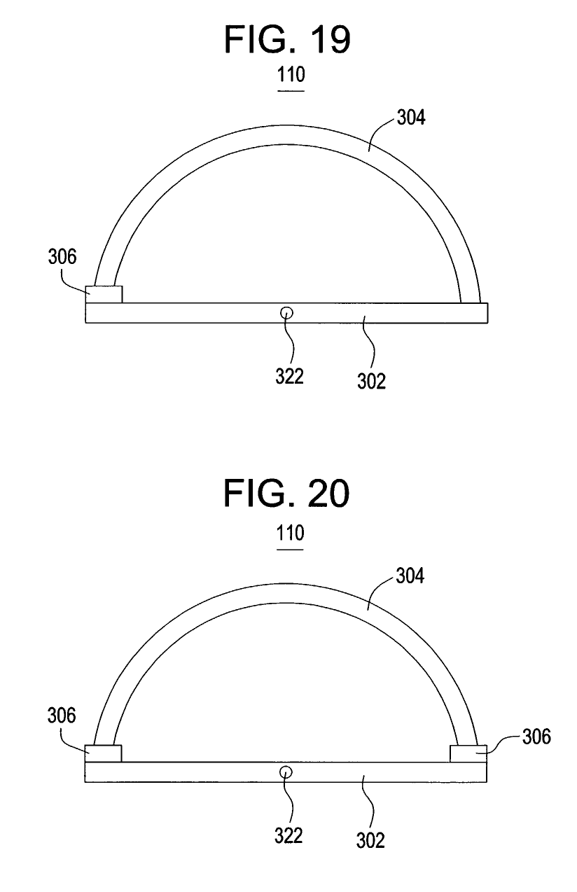

FIGS. 18-20 show the semicircular cylinder in which the connector(s) 306 is/are disposed at the end(s) of the flexible portion 304. FIG. 18 shows an example in which a connector 306 is disposed on the right side; FIG. 19 shows an example in which a connector 306 is disposed on the left side; and FIG. 20 shows an example in which connectors 306 are disposed on both the sides. Every configuration has the connector(s) at a position other than the top portion, and an increase of height due to the connector(s) can be prevented.

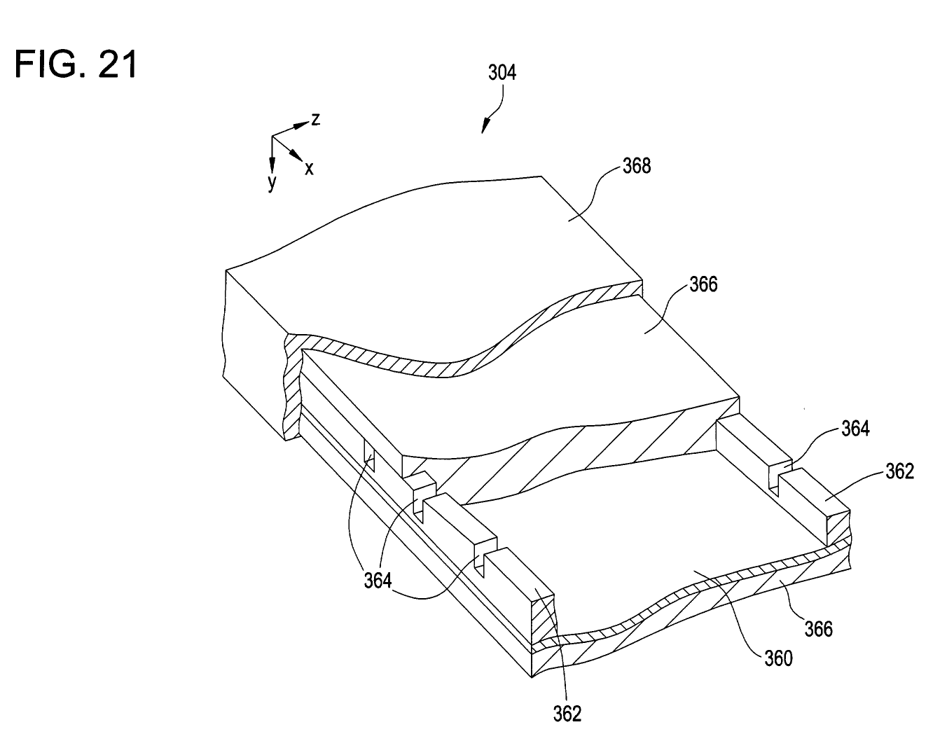

FIG. 21 shows the internal structure of the flexible portion 304 in a partially broken-away view. It should be noted that in FIG. 21 the vertical dimension is exaggerated for convenience of illustration. In FIG. 21, x, y, and z represent three coordinate axes orthogonal to one another. The x-direction is defined as the right-left direction, the y-direction as the upper-lower direction, and the z-direction as the axial direction, of the receive coil section 110.

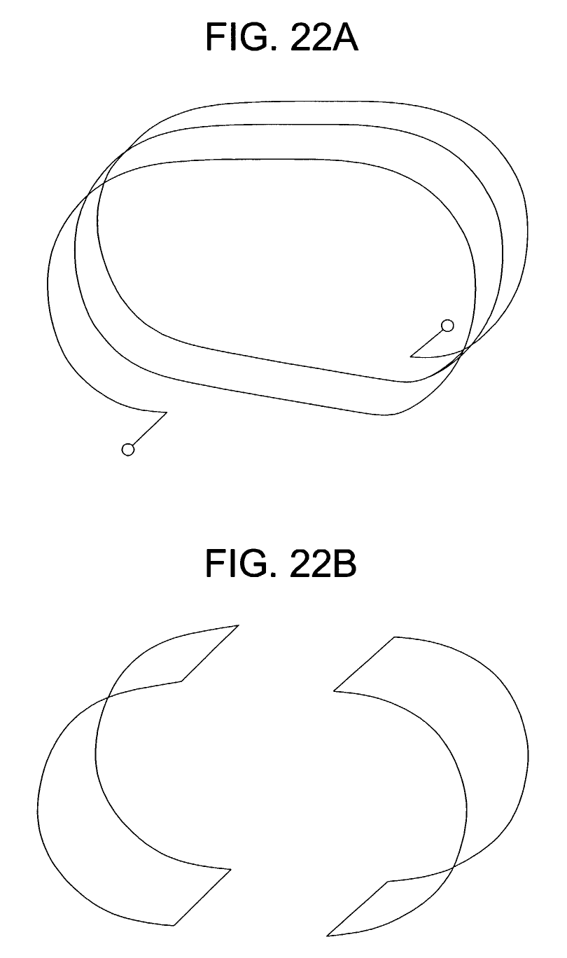

As shown in FIG. 21, the flexible portion 304 comprises a flexible substrate 360. The flexible substrate 360 is provided with an electric path pattern (not shown), which may be formed as a printed circuit, for example. When the cylinder is formed, the electric circuit constitutes a solenoid coil as shown in FIG. 22(a) or a saddle coil as shown in FIG. 22(b), for example. Each electric circuit is an embodiment of the electric circuit for the RF coil of the present invention.

The edges of the upper surface of the flexible substrate 360 are provided with a pair of shape defining members 362 over the length of the flexible substrate 360. The upper surface of the flexible substrate 360 corresponds to the inner side when the cylinder is formed. The shape defining members 362 are made of a plastic material, for example.

The shape defining members 362 have a predefined thickness in the y-direction such that flexibility is substantially avoided. The shape defining members 362 have a plurality of U-shaped notches 364. The notches 364 are cut in the z-direction and open upwards.

The notches 364 have a depth approximately equal to the thickness of the shape defining member 362. Thus, the thickness of the notch 364 at the bottom is extremely reduced to obtain sufficient flexibility. Alternatively, the thickness at the bottom may be zero.

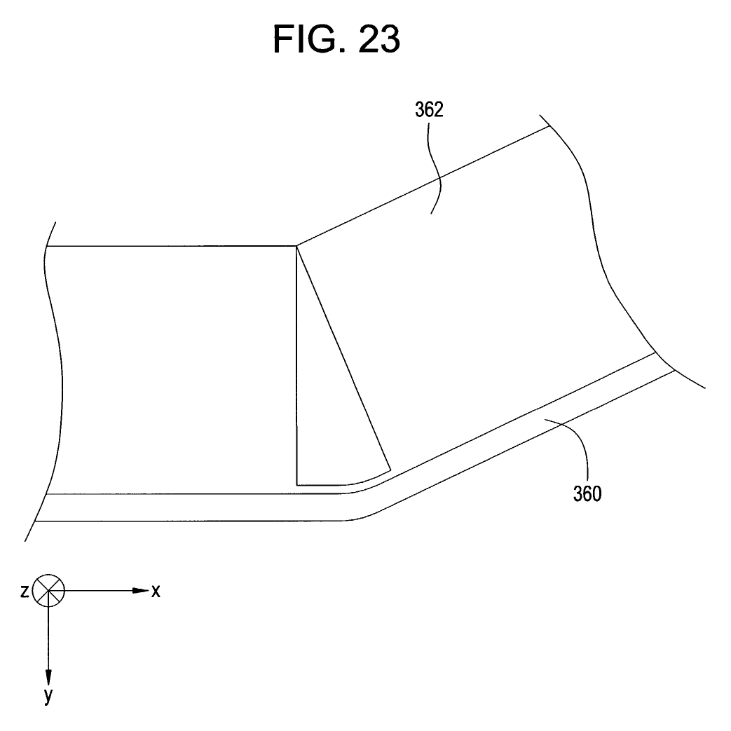

Such shape defining members 362 allow the flexible substrate 360 to bend only at the flexible portions of the shape defining member 362 (i.e., at the bottom of the notches) when the flexible substrate 360 is curved in a direction of forming a cylinder, and the bending amount is limited to that at which the openings of the notches 364 close, as schematically shown in FIG. 23. The allowable bending amount is determined by the width of the notches, i.e., the wider the width of the notches, the larger is the bending allowance range.

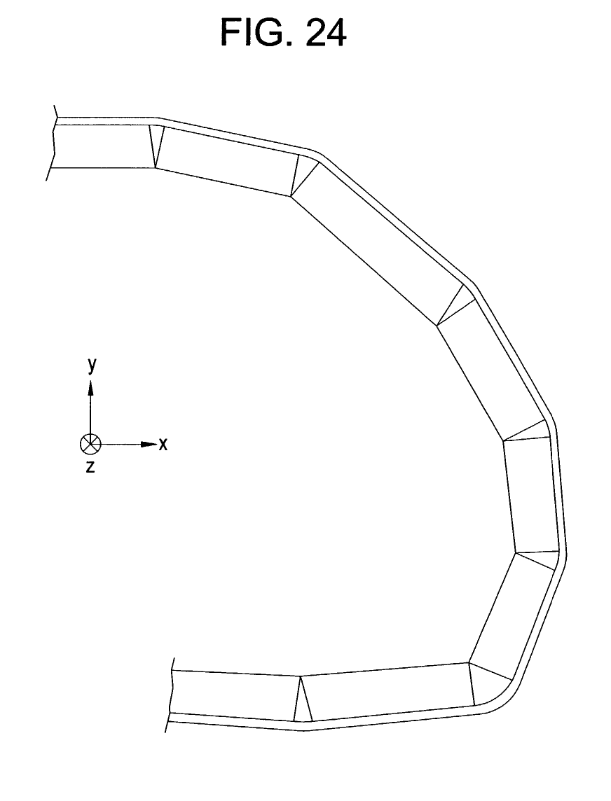

The width and the spacing in the x-direction of the notches 364 are determined according to the bending amount of every portion of the flexible substrate 360 in forming the cylinder. Thus, bending of the flexible substrate 360 as exemplarily and schematically shown in FIG. 24 is obtained when the cylinder is formed. Although only the right portion is shown in FIG. 24, the left portion is symmetric with the right portion.

Such bending uniquely defines a curved shape of the cylinder, or the receive coil section 110. By fixing the curved shape, the electromagnetic condition of the receive coil section 110 is fixed, thereby enabling stable imaging.

Over the shape defining member 362 and the flexible substrate 360 is provided a shock absorbing member 366 of sponge, for example. A similar shock absorbing member 366 is provided on the lower surface of the flexible substrate 360.

All the above structures are enclosed in an envelope 368. The envelope 368 is fixed to the base portion 302 at an end on the fixed end side of the flexible portion 304, and an end on the free end side is fixed to the connector 306. The fixing of the both ends is achieved by any appropriate means such as bonding, nipping, riveting, or sewing.

While the present invention has been described with reference to preferred embodiments hereinabove, various changes or substitutions may be made on these embodiments by those ordinarily skilled in the art pertinent to the present invention without departing from the technical scope of the present invention. Therefore, the technical scope of the present invention encompasses not only those embodiments described above but all that fall within the scope of the appended claims.

Many widely different embodiments of the invention may be constructed without departing from the spirit and the scope of the present invention. It should be understood that the present invention is not limited to the specific embodiments described in the specification, except as defined in the appended claims.

1. An RF coil comprising:
a panel-like base member;
a flexible member having an electric circuit for the RF coil, bending to surround a space adjacent to one surface of said base member, having both ends joined to said base member, and forming a generally circular cylinder along with said base member; and
a connecting member enabling connection and disconnection of the circumferential continuity of said cylinder at a position other than one corresponding to the top portion of said cylinder of said flexible member.

2. The RF coil of claim 1, wherein said connecting member is disposed at a position other than an end of said flexible member.

3. The RF coil of claim 1, wherein said connecting member is disposed at an end of said flexible member.

4. The RF coil of claim 1, wherein said connecting member is disposed at two positions opposite to each other with respect to the center axis of said cylinder.

5. An RF coil comprising:
a panel-like base member;
a flexible member having an electric circuit for the RF coil, bending to surround a space adjacent to one surface of said base member, having both ends joined to said base member, and forming a generally semicircular cylinder along with said base member; and
a connecting member enabling connection and disconnection of the circumferential continuity of said cylinder at a position other than one corresponding to the top portion of said cylinder of said flexible member.

6. The RF coil of claim 5, wherein said connecting member is disposed at a position other than an end of said flexible member.

7. The RF coil of claim 5, wherein said connecting member is disposed at an end of said flexible member.

8. The RF coil of claim 5, wherein said connecting member is disposed at two positions opposite to each other with respect to the center axis of said cylinder.

9. A magnetic resonance imaging apparatus having:
a static magnetic field generating device for generating a static magnetic field in a space for receiving a subject to be imaged,
a gradient magnetic field generating device for generating a gradient magnetic field in said space,
a high frequency magnetic field generating device for generating a high frequency magnetic field in said space,
a measuring device for measuring magnetic resonance signals from said subject, and
an image producing device for producing an image based on said magnetic resonance signals,
wherein said measuring device has an RF coil,
said RF coil comprising:
a panel-like base member;
a flexible member having an electric circuit for the RF coil, bending to surround a space adjacent to one surface of said base member, having both ends joined to said base member, and forming a generally circular cylinder along with said base member; and
a connecting member enabling connection and disconnection of the circumferential continuity of said cylinder at a position other than one corresponding to the top portion of said cylinder of said flexible member.

10. The magnetic resonance imaging apparatus of claim 9, wherein said connecting member is disposed at a position other than an end of said flexible member.

11. The magnetic resonance imaging apparatus of claim 9, wherein said connecting member is disposed at an end of said flexible member.

12. The magnetic resonance imaging apparatus of claim 9, wherein said connecting member is disposed at two positions opposite to each other with respect to the center axis of said cylinder.
